(19) United States
(12) Patent Application Publication
(10) Pub. No.: US 2010/0222626 A1
(43) Pub. Date: Sep. 2, 2010

(54) METHOD OF TREATING A BIOMASS MATERIAL

(75) Inventor: Koichiro Nakamura, Tokyo (JP)

Correspondence Address: HAMRE, SCHUMANN, MUELLER & LARSON, P.C., P.O. BOX 2902, MINNEAPOLIS, MN, 55402-0902, US

(73) Assignee: NIPPON SHEET GLASS COMPANY, LIMITED, Tokyo (JP)

(21) Appl. No.: 12/395,054

(22) Filed: Feb. 27, 2009

(51) Int. Cl. A62D 3/37; B09B 3/00

(52) U.S. Cl. 588/319; 588/249

(57) ABSTRACT

The present inventions are made from a viewpoint of such problems of the prior art, it is an object of the present invention to provide a good biomass.

A method of treating a biomass material according to the present invention is characterized in that arsenic, antimony, selenium, chromium and/or copper contained in a biomass material is (are) adsorbed and eliminated by the use of an adsorbent containing a rare-earth metal compound. The method is characterized in that after the above arsenic, antimony and/or selenium is (are) selectively adsorbed and eliminated, further the above chromium and/or copper is (are) selectively adsorbed and eliminated.

### FIELD OF THE INVENTION

The present invention relates to a method of treating a biomass material, in particular, the invention relates to a method of treating a biomass material with the use of an adsorbent containing a rare-earth metal compound.

1. Background of the Invention

Recently, a biofuel (bioethanol) globally draws attention as an alternative energy of an oil resources such as gasoline. Although a business for producing a biofuel from a starch based material such as a saccharum officinarum or a corn are developing, the deterioration of a global food situation was caused by running up a price of these materials. Therefore, the use of a cellulose based material such as a recycled waste-paper, or a thinned wood as a material of biofuel is desired.

When the biofuel is produced from a cellulose based material, in general, it mainly comprises, (1) a step of the saccharification from cellulose to glucose, (2) a step of the fermentation from glucose to ethanol. (Patent literature 1 and 2)

On the other hand, from 1960s, pesticides containing chromium, copper and arsenic for a base of a house or a wood for telephone poles in order to prevent the woods from decay and ant had been used. Today, these pesticides is rarely used from a viewpoint of these toxicity. However, it is expected that these woods treated by the pesticides (CCA treated woods) is discharged as a waste product in a large amount. Currently, a waste product of the CCA treated woods is mostly treated by the incineration or landfill.

2. Prior Art

[Patent Literature]

[Patent literature 1]: JP-A-2006-149343

[Patent literature 2]: JP-A-2008-92883

There is problem that a microbial fermentation in the above step of fermentation to ethanol is inhibited in the case of the use of such CCA treated woods as a raw material for bioethanol because of the toxicity of chromium and arsenic. This is because it is thought that for the production of ethanol from a wood based biomass material, a waste wood is grinding treated, and separating them into cellulose and hemicellulose by thermochemical treatment, and saccharizing cellulose to glucose by cellulase, and saccharizing hemicellulose to xylose by xylanase, and converting a sugar (glucose and xylose) to ethanol with a yeast or a thermophilic bacterium, and in this case, an enzyme reaction of cellulose, xylanase, yeast etc., is inhibited by the toxicity of arsenic, chromium.

Further, it is still problem that even if chromium, copper, arsenic can be separated from a CCA treated waste wood, there are no method of treating an inorganic arsenic and chromium having a high toxicity and cancer-causing property.

### SUMMARY OF THE INVENTION

Therefore, the present inventions are made from a viewpoint of such problems of the prior art, it is an object of the present invention to make it possible to use a waste wood etc., as a biomass material which can be not used for a biomass material, such as a CCA treated wood, by eliminating a harmful material contained in a biomass material safely and effectively. Further, it is an object of the present invention to provide a method of treating a biomass material, capable of safely treating arsenic etc., collected from a biomass material, capable of eliminating and collecting rare metals while, and useful for purification of ethanol.

In order to accomplish the above objects, the present inventors made strenuous studies on the effects of adsorbent for the component of metal. As a result, the inventors discovered the method of treating a biomass material according to the present invention.

That is, a method of treating a biomass material according to the present invention is characterized in that arsenic, antimony, selenium, chromium and/or copper contained in a biomass material is (are) adsorbed and eliminated by the use of an adsorbent containing a rare-earth metal compound.

### EFFECT OF THE INVENTION

The present invention has an advantageous effect that it is possible to provide a good biofuel, with no inhibition of fermentation of microorganisms, even if a biomass material containing a harmful material is used. Further, it also has an advantageous effect that it is possible to detoxify a metal such as, arsenic or chromium etc., and recycle them by purification because arsenic or chromium etc., can be separated by the present invention.

### BRIEF DESCRIPTION OF THE DRAWINGS

For a better understanding of the invention, reference is made to the attached drawings, wherein:

FIG. 1 gives a scheme of the detoxification of arsenic in a waste wood, and the recycle of chromium and copper as an example.

FIG. 2 gives a result of an adsorption test as to the aqueous solution of chromium.

FIG. 3 gives a result of an adsorption test as to arsenic ion.

FIG. 4 gives a result of an adsorption test as to copper ion.

FIG. 5 gives a result of an adsorption test as to the aqueous solution containing both chromium ion and arsenic ion.

FIG. 6 gives a result of an adsorption test as to the aqueous solution containing both copper ion and arsenic ion.

FIG. 7 gives a result of an adsorption test as to the aqueous solution containing both chromium ion and copper ion.

FIG. 8 gives a result of an adsorption test as to the aqueous solution containing chromium ion, arsenic ion and copper ion.

### DESCRIPTION OF THE PREFERRED EMBODIMENTS

The method of treating a biomass material according to the present invention will be explained.

The present invention is characterized in that arsenic, antimony, selenium, chromium and/or copper contained in a biomass material is (are) adsorbed and eliminated by the use of an adsorbent containing a rare-earth metal compound. The “biomass” means generally an accumulation of an organic substance derived from an organism or an organism incorporated in a circulating system of materials in a global biosphere, for example, there are a starch based and a cellulose based but it is not particularly limited.

As a material of biomass, for example, mention may be made of a plant (timber, crop etc.), those produced from a plant (paper, wood, food etc.), waste paper, leftover food, ever woods arising from architecture, waste product such as a raw sludge and waste wood product. In the present invention, it is possible to produce ethanol even if these biomass raw materials include arsenic, antimony, selenium, chromium or copper. Therefore, it is also possible to use CCA treated woods as a biomass raw material which were mostly treated by incineration or landfill in the past.

In a preferred embodiment, after the above arsenic, antimony and/or selenium is (are) selectively adsorbed and eliminated, further the above chromium and/or copper is (are) selectively adsorbed and eliminated. In order to separate chromium, copper etc., perfectly, a separation treatment of the conventional procedure can be used. For example, a cation-exchange resin can be used or a reduction neutralization precipitate method etc., can be used.

Hereby, a harmful arsenic etc., and chromium and copper which are a rare metal are separated each other, a harmful arsenic etc., can be carried out by the treatment of the detoxification as described later, and the rare metals are reduced again for industrial circles. That is, in the present invention, it has incidental effects that it is possible to provide most suitable biomass, in addition, to attain the detoxification of a harmful compound such as arsenic etc., and as to the rare metal, to reduce it again for industrial circles after purification. In order to contact treat water containing a waste wood and an adsorbent, multiple number of a bath are prepared, at first, arsenic etc., can be adsorbed and eliminated, and then the other metals can be adsorbed and eliminated. Conclusively, it is enough if Cu etc., can be eliminated which are substances having an influence on ethanol fermentation.

The adsorbent used in the present invention contains a rare-earth metal compound. The rare-earth metal compound is not particularly limited to, as long as it can adsorb arsenic, antimony, selenium, chromium, and/or copper, but it is preferable to be at least one oxide, hydrate or hydroxide selected from the group comprising cerium (Ce), samarium (Sm), neodymium (Nd), gadolinium (Gd), lanthanum (La), yttrium (Y).

Among them, in a viewpoint that it is possible to use them with a form of oxide, hydrate or hydroxide, and with a form of a fine particulate, ceric oxide hydrate (CeO₂.1.6H₂O), samarium oxide hydrate (Sm₂O₃.4.1H₂O), neodymium oxide hydrate (Nd₂O₃.4.7H₂O), gadolinium oxide hydrate (Gd₂O₃.5.0H₂O), lanthanum oxide hydrate (La₂O₃.3.0H₂O), yttrium oxide hydrate (Y₂O₃.2.1H₂O), cerium hydroxide (Ce(OH)₃ or Ce(OH)₄) are preferable. Further, from the viewpoint of cut-down of the treatment time, cerium compound which has a larger coupling constant with the inorganic arsenic is preferable, in particular, hydrated oxide of cerium, or oxide, hydrate or hydroxide of cerium are preferable.

Moreover, a water-absorbing substance may be mixed with the adsorbent. As a water-absorbing substance, it is particularly limited, but stating with diatom earth having silicon oxide (SiO₂) as main component, activated carbon, Silas Balloons, peat, pumice etc., can be used, and these substances are preferable used as a form of fine particle. Among these water-absorbing substances, diatom earth is particularly preferable since it has excellent water-absorbing property and water permeability and it is relatively low price.

Although it is unclear why arsenic, selenium, antimony etc., can be adsorbed with the rare-earth metal compound, including cerium hydroxide (hydrated cerium oxide), it is thought that it can be bound to the surface of the rare-earth metal compound, such as cerium compound through a metal and hydroxyl group, and the present inventor finds the method of treating a biomass with utilizing such specific pattern of coupling.

In the present invention, specific method or embodiment of the adsorption is also not particularly limited. In the present invention, as long as substances to be treated which contain a harmful compound such as arsenic may be contacted with the adsorbent, it is enough. When the substances to be treated is contacted with the adsorbent, because it is though that a stir and/or a heat and/or solvent dilution have an effect that it makes the reaction system uniform, in addition to this, they have an effect that it makes the adsorption reaction occur easily by making bare the inorganic compound existing in the substances to be treated, the use of a stir and/or a heat and/or solvent dilution are preferable. In this case, the adsorbent are preferably dispersed in a solution mixed with both solvent such as water or oil and the substances to be treated, alternatively, a solution of the substances to be treated is preferably passed through an adsorption tower filled with the adsorbent.

And so forth, it may contact with stirring in the batch adsorption bath, on the other hand, it may contact with the fixed bed or fluid bed. Moreover, it may contact by filling or attaching to the adsorption system according to the prior art, such as a rotary type of the adsorption tower or fix type of the adsorption tower. Alternatively, it may contact by directly putting the adsorption enclosed to a porous material such as a net into a vessel such as a pole transformer.

The contact time and the contact temperature of the liquid containing the adsorbent and the harmful compound are not particularly limited, and it may contact under a stir and/or a heat. The contact time may be selected, depending on an initial concentration of the harmful compound, a type of the solvent (oil or water), a contact temperature, a type of the adsorbent etc. As to the treatment time, necessary time is fixed, depending on a fluid volume, an amount or a form of the adsorbent etc., but industrially, it is preferably within 1 week or 1 day. If the contact time is too short, the adsorption is not enough while, if it is too long, there is no sense because it attains a saturated amount of the adsorption. As to the contact temperature, it is not particularly limited as long as it is possible to treat it as the liquid. From the viewpoint of the outline of work, lower temperature is desirable. According to need, the liquid containing the harmful compound can be heated, a heating means is not particularly limited, but for example, mention may be made of a heat from outside such as a heater, a heat from inside such as immersion type of heating, a heat by microwave or ultrasonic wave. Moreover, concerning a scope of pH, it is not particularly limited, but if a scope of pH is 1 to 10, preferably 3 to 9, arsenic tends to be easily adsorbed.

Moreover, in the case that it contacts under a stir, a condition of a stir is not particularly limited. A method capable of rendering a convection to the liquid containing the harmful compound directly or indirectily is preferable. For example, mention may be made of (1) a method of stirring a liquid containing a chlorinated organic compound with the use of a stirring system such as an agitator blade or a magnetic stirrer, (2) a method of vibrating a vessel filling a liquid containing the harmful compound (for example, member of a pole transformer) with the use of a vibration type of the stirring mill, vibrating table, vibrating machine etc., (for example, a method of parallel-vibrating in a direction perpendicular and/or horizontal, a method of circumnutate-vibrating etc.), (3) a method of rendering a vibration to the liquid filled in the above vessel with the use of ultrasonic waves or magnet etc.

As just described, in the present invention, a method of contacting a substance to be treated with the adsorbent mentioned in the present invention, is not particularly limited. It can be separated by utilizing the adsorbent mentioned in the present invention, with adopting a traditional method according to chromatography separation. Moreover, the above mentioned adsorbent may be used it self, and may be used with the combination of a adsorbent other than the rare-earth metal compound.

Moreover, in the present invention, it has an advantageous effect that not only it makes it possible to treat in large scale and at a low price because of the use of the rare-earth metal compound as the adsorbent, but also it makes it possible to collect the adsorbed arsenic, antimony, selenium easily. For example, the adsorbent which adsorbs arsenic etc., is put in and mixed with a treatment solution containing hydrogen peroxide controlled to about pH 7 to 11, to make it possible to eliminate arsenic etc., into the treatment solution.

The collected arsenic, antimony, selenium in this way may be converted to those having a lower toxicity by a step of synthesizing an alkylated or arylated arsenic, an alkylated or arylated antimony, an alkylated or arylated selenium by the methylation. Moreover, it is possible to recycle the adsorbent after eliminating arsenic etc.

As a methylation treatment of the collected arsenic etc., for example, it is possible to carry out the methylation treatment by reacting arsenic etc., with the organic halide compound etc., to methylate arsenic, and thereby obtaining dimethylated compound, trimethylated compound. Moreover, it is also possible to carry out the methylation treatment of arsenic by accumulating the collected arsenic etc., into the phytoplankton etc., to alkylate or arylate it. This makes it possible to attain the detoxification by converting the harmful inorganic arsenic etc., into more harmless organic arsenic compound etc., such as methylated arsenic with the use of the physiological reaction in an inside of phytoplankton. In particular, from a viewpoint that when arsenic is alkylated up to arsenocholine, or arsenobetaine etc., by the mathylation etc., of arsenic, these substances are stable substances since under the ordinary circumstances, the demethylate reaction and degradation rarely occur, conclusively it is preferable to detoxify them up to arsenocholine, or arsenobetaine.

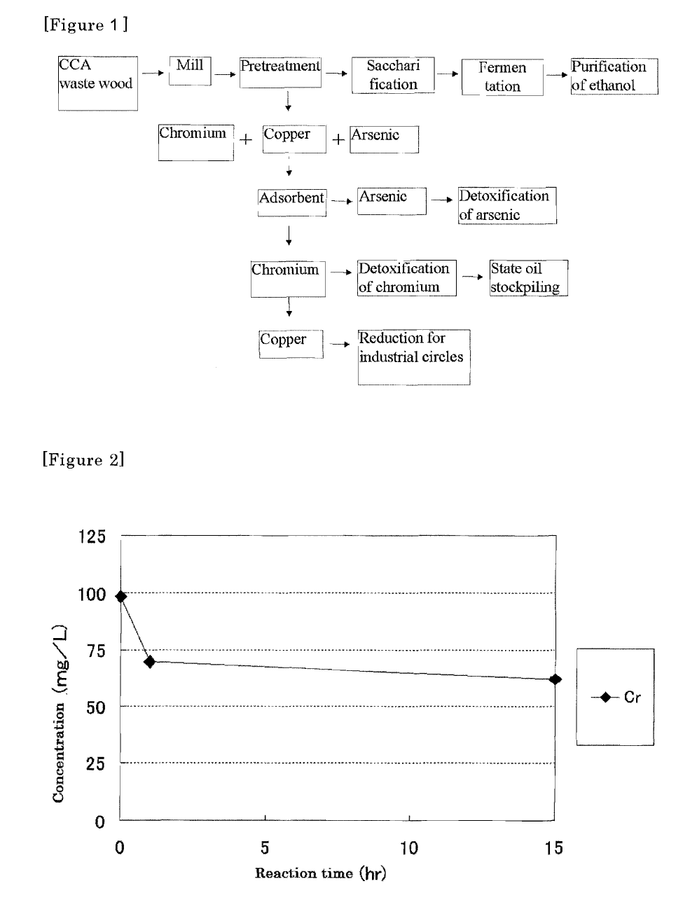

FIG. 1 gives a scheme of the detoxification of arsenic existing in a waste wood, and the recycle of chromium and copper as an example.

The CCA waste wood is crushed with using an appropriate mill. A method of crushing waste wood is carried out according to a common procedure. Next, the crushed waste wood is pretreated. The pretreatment is steps of the adsorption and separation of the present invention as mentioned before, it is possible to pretreat with the use of the adsorbent. The waste wood that chromium etc., are separated by the pretreatment, can be saccharized and fermented according to the common procedure to obtain ethanol. The saccharification and the fermentation are not particularly limited. It may be carried out by the use of appropriate amount of cellulase and yeast etc. The addition of cellulose is for obtaining sugar such as glucose by disgregating cellulose. The addition of yeast is for carrying out the alcohol fermentation by resolving glucose etc., produced by cellulase to produce ethanol.

On the other hand, it is possible to adsorb and eliminate chromium, copper, arsenic separated by the pretreatment with the use of the adsorbent explained in the present invention, or in combination with a method of eliminating them according to the common procedure and the adsorbent explained in the present invention.

Chromium exists as 0 valent, 2 valent, 3 valent and 6 valent, among them, metal chromium of 0 valent is biologically inactive, does not show toxicity. 3 valent of chromium is a small amount of an essential element of the animal, it is known that if it lacks, it is known that it bring about the decrease of carbohydrate tolerance, the increase of blood fat, atherosclerotic cardiovascular disease etc. As the treatment of chromium, including 6 valent of chromium having a high toxicity, a reduction neutralization precipitate method is generally used. This method is characterized in that 6 valent of chromium is reduced to 3 valent of chromium under the condition of the strong acidity which is less or equal to pH2, after that, to this added alkali and thereby being precipitated and removed as chromium hydroxide.

Other than the use of the adsorbent explained in the present invention, alternatively in combination with the adsorbent, chromium can be treated with the use of a method of treating chromium according to the common procedure.

As to copper, it is possible to adsorb and eliminate it with the use of the adsorbent used by the above present invention, or with the use of the other adsorbent which is commercially available. These method of eliminating copper according to the common procedure can be also used.

By reference to FIG. 1, it will be summarized as follows. The present invention makes it possible to separate arsenic, copper, chromium from the CCA treated waste woods, and to detoxify arsenic, chromium. Arsenic can be isolated and preserved as a harmless arsenic. Chromium can be detoxified by converting 6 valent to 3 valent, it is possible to be available for state oil stockpiling since it is rare metal. The method of detoxifying chromium according to the common procedure can be available, and it is not particularly limited. Moreover, copper can be reduced for industrial circles since it is a base metal for industry. Finally, a CCA free waste wood can be provided for the production of the bioethanol as a biomass. Moreover, the steps of a mill, saccharification, fermentation etc., in the scheme is not particularly limited, depending on the common procedure.

### EXAMPLE

The present invention will be explained with reference to Examples, but the invention is not intended to be interpreted as being limited to Examples.

### Example 1

Into a 1.5 mL volume of Eppendorf tube 1 m L of an ultrapure water, an aqueous solution containing a given amount of chromium, arsenic, copper shown in the table 1 (A standard solution for an atomic absorption, 1000 mg/L) were added and prepared to become a 100 mg/L. To this solution, were added 0.1 g of a heavy metal adsorbent be ground in a mortar (Nippon Sheet Glass Company, limited, ADCERA, which is calcined and granulated by mixing a diatom earth and a rare-earth metal compound). This was stirred in constant-temperature bath maintained at 30° C., with sampling each 30 μL of those after 1 hour and 15 hours, respectively to dilute with the ultrapure water to obtain a total amount of 3 mL, and then a concentration of the metal was analyzed by an ICP-MS method. An initial concentration is shown in the table 1, a variation per hour of the concentration of a metal ion in the adsorption test is shown in the table 2.

TABLE 1

| | |
|---|---|
| | Initial additive |
| Initial | amount |

| | concentration | | | Ultrapure | |
|---|---|---|---|---|---|
| | Cr | As | Cu | water | Adsorbent |
| No. | ppm | ppm | ppm | mL | g |
| 1 | 100 | 0 | 0 | 1 | 0.1 |
| 2 | 0 | 100 | 0 | 1 | 0.1 |
| 3 | 0 | 0 | 100 | 1 | 0.1 |
| 4 | 100 | 100 | 0 | 1 | 0.1 |
| 5 | 0 | 100 | 100 | 1 | 0.1 |
| 6 | 100 | 0 | 100 | 1 | 0.1 |
| 7 | 100 | 100 | 100 | 1 | 0.1 |

TABLE 2

| | a: adsorption test | | | a: adsorption test | | | a: adsorption test | | |
|---|---|---|---|---|---|---|---|---|---|
| | (0 hr) | | | (1 hr) | | | (15 hr) | | |
| | b: Analytical value | | | b: Analytical value | | | b: Analytical value | | |
| | (ppm) | | | (ppm) | | | (ppm) | | |
| No. | Cr | As | Cu | Cr | As | Cu | Cr | As | Cu |
| 1 | 98 | 0 | 0 | 70 | 0 | 0 | 62 | 0 | 0 |
| 2 | 0 | 104 | 0 | 0 | 3 | 0 | 0 | 1 | 0 |
| 3 | 0 | 0 | 102 | 0 | 0 | 84 | 0 | 0 | 61 |
| 4 | 0 | 103 | 0 | 92 | 9 | 0 | 82 | 1 | 0 |
| 5 | 0 | 108 | 106 | 0 | 6 | 93 | 0 | 1 | 85 |
| 6 | 101 | 0 | 104 | 75 | 0 | 89 | 66 | 0 | 79 |
| 7 | 101 | 107 | 105 | 88 | 8 | 96 | 81 | 1 | 86 |

a: adsorption test
b: Analytical value

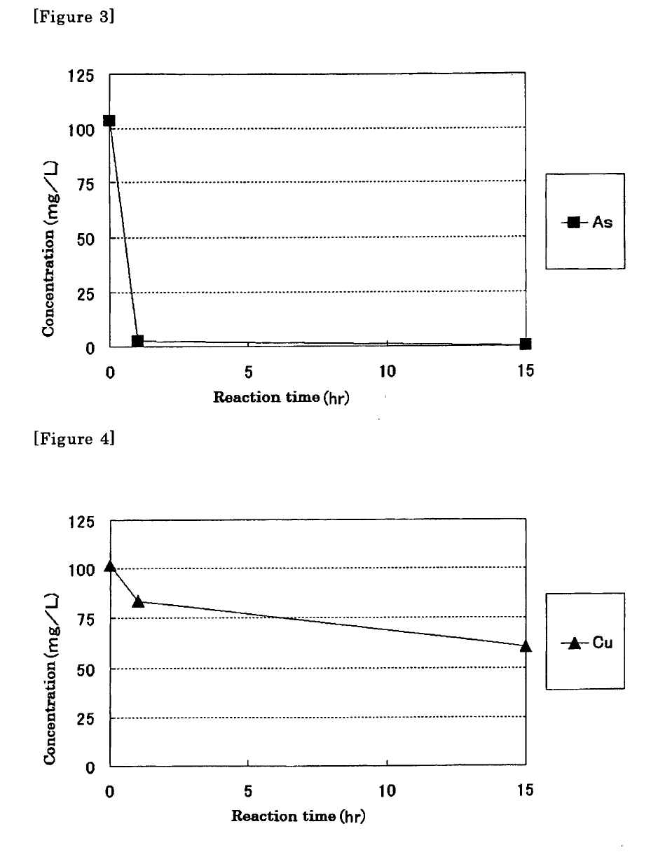

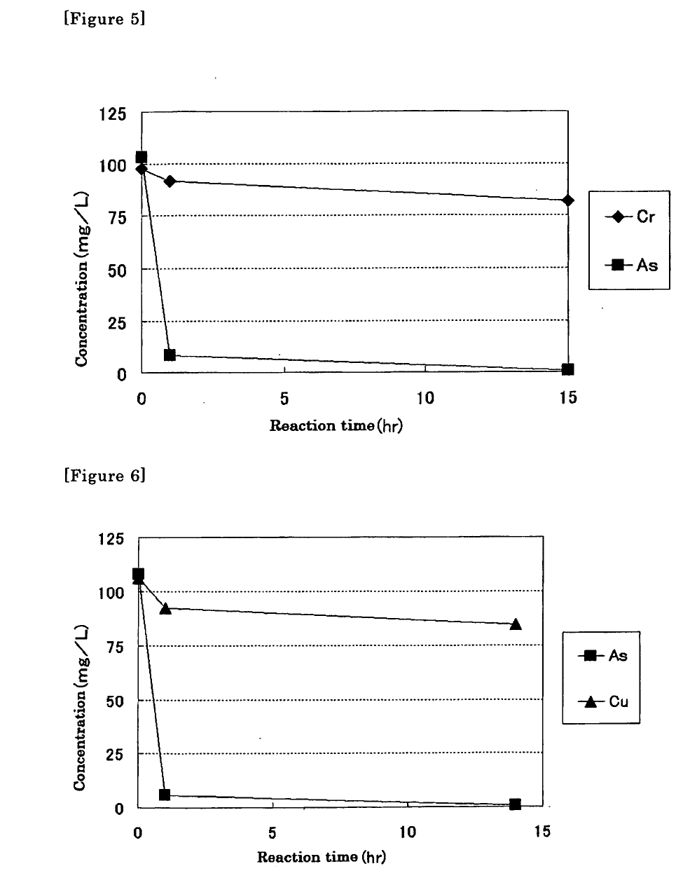

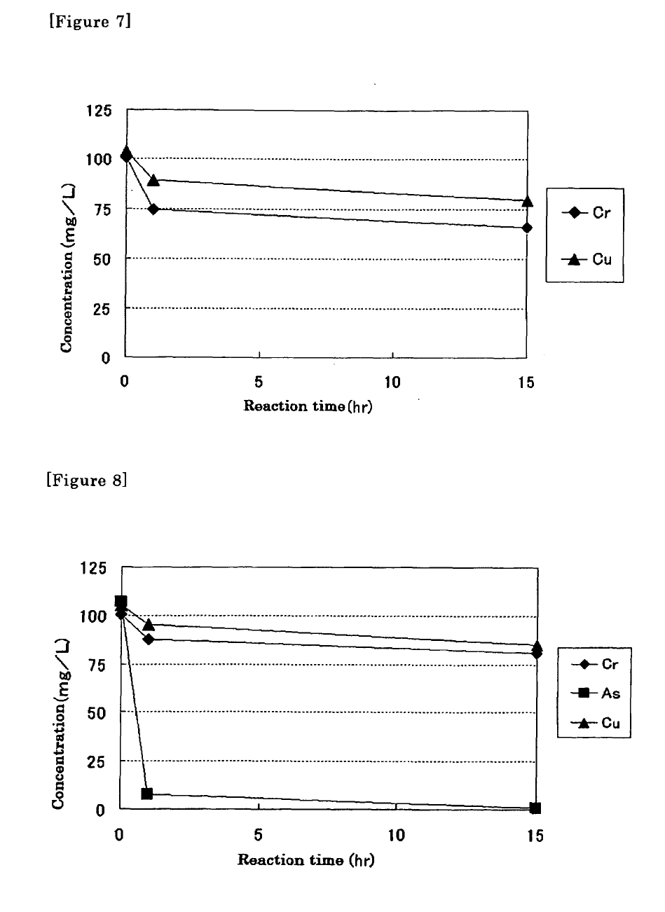

FIG. 2 gives a result of an adsorption test as to the aqueous solution of chromium. FIG. 3 gives a result of an adsorption test as to arsenic ion. FIG. 4 gives a result of an adsorption test as to copper ion. FIG. 5 gives a result of an adsorption test as to the aqueous solution containing both chromium ion and arsenic ion. FIG. 6 gives a result of an adsorption test as to the aqueous solution containing both copper ion and arsenic ion. FIG. 7 gives a result of an adsorption test as to the aqueous solution containing both chromium ion and copper ion. FIG. 8 gives a result of an adsorption test as to the aqueous solution containing chromium ion, arsenic ion and copper ion. Moreover, it was revealed that arsenic was selectively adsorbed from the aqueous solution containing indium, gallium arsenic (FIG. 8). As a result of this, it was revealed that it is possible to adsorb and eliminate arsenic at first step when multiple steps of adsorption are set such as two steps, and then to adsorb and eliminate the other metal other than arsenic.

### Example 2

Next, the synthesis of an organic metal compound by methylating arsenic with the use of methylcobalamin will be explained. The conformation of methylcobalamin, and a reactive process of detoxifying arsenic are shown in the [Chemical 1].

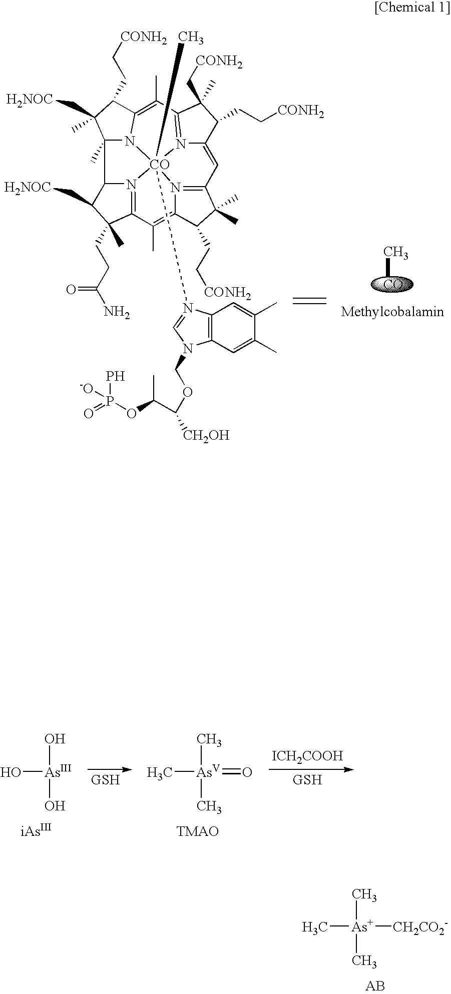

Into a 0.2 mL of Eppendorf tube 60 mg of a reduced glutathione (GSH) (0.195 mmoL), 10 mg of methylcobalamin (7.44 μmoL), Tris-HCL buffer solution (pH 8, 50 μL) were added. To this, 2 μL of arsenic standard solution (for an atomic absorption, 100 ppm as arsenic) was added, and then it was set on an aluminum block heater heated at 125° C. to be reacted for a predetermined time. The reaction production was diluted 10 folds with 10% of the hydrogen peroxide solution, and analyzed by HPLC-ICP-MS method. The arsenic compounds in the reaction mixture was 99.2% of trimethyl arsine oxide (TMAO), 0.8% of tetramethyl arsonium (TeMA).

Further, trimethyl arsine oxide (TMAO) (0.267 μM) and a reduced glutathione (GSH) (5 mM) were reacted in 100 mM of phosphoric acid-citric acid buffer solution (pH 5) for 37° C. for 100 hours, and then the production amount of TMAO and arsenobetaine (AB) were assayed by HPLC-ICP-MS. A relative ratio of the arsenic compound in the reaction mixture was 0.5% for TMAO, 99.5% for AB, respectively.

### INDUSTRIAL APPLICABILITY

It is possible to selectively adsorb a harmful compound and a rare metal such as arsenic, copper, chromium existing in the waste woods etc., and to collect these metal more safely by the present inventions. It can be introduced broadly as a excellent CCA treatment technique capable of being used in the production of ethanol.

1. A method of treating a biomass material, comprising adsorbing and eliminating at least one selected from the group consisting of arsenic, antimony, selenium, chromium and copper contained in a biomass material by treatment with an adsorbent containing a rare-earth metal compound.

2. A method of treating a biomass material according to claim 1, wherein after any arsenic, antimony and/or selenium is (are) selectively adsorbed and eliminated, further any chromium and/or copper is (are) selectively adsorbed and eliminated.

3. A method of treating a biomass material according to claims 1, wherein the rare-earth metal compound is at least one oxide, hydrate or hydroxide selected from the group comprising cerium, samarium, neodymium, gadolinium, lanthanum, yttrium.

4. A method of treating a biomass material according to claim 1, wherein the biomass material is a waste wood treated by a pesticide agent containing chromium, copper and arsenic.

5. A method of treating a biomass material according to claims 1, wherein the method comprises a step of detoxifying the adsorbed arsenic, antimony or selenium by converting them to an alkylated or arylated arsenic, an alkylated or arylated antimony, an alkylated or arylated selenium, respectively.
